(19) United States
(12) Patent Application Publication
(10) Pub. No.: US 2014/0302994 A1
(43) Pub. Date: Oct. 9, 2014

(54) APPARATUSES, SYSTEMS, AND METHODS RELATING TO SUPERCONDUCTING TRAPPED FIELD MAGNET CARTRIDGES

(71) Applicants: Dean Sarandria, Jonestown, TX (US); Kuan-Chen Chen, Austin, TX (US); Glenn Knierim, Cedar Park, TX (US)

(72) Inventors: Dean Sarandria, Jonestown, TX (US); Kuan-Chen Chen, Austin, TX (US); Glenn Knierim, Cedar Park, TX (US)

(21) Appl. No.: 13/824,345

(22) PCT Filed: Oct. 9, 2012
(86) PCT No.: PCT/US12/00513

§ 371 Date: Mar. 15, 2013

Related U.S. Application Data
(60) Provisional application No. 61/568,344, filed on Dec. 8, 2011.

(51) Int. Cl. H01F 6/04; H02K 9/00; F17C 13/00; H02K 1/02

(52) U.S. Cl. CPC H01F 6/04; H02K 1/02; H02K 9/00; F17C 13/002; F17C 2203/0612
USPC 505/163; 310/180; 62/51.1

(57) ABSTRACT

A cryostat cartridge is disclosed. The cryostat cartridge may include a cryostat having a cryogen inlet, a cryogen outlet, and a superconductor material inside the cryostat configured to be cooled by a cryogen entering the cryostat through the cryogen inlet and exiting the cryostat through the cryogen outlet. The cryogen inlet is configured to be detachable from a cryogen source. The cryostat cartridge may be inserted into an activation module for activating the superconductor material and may also be inserted into a superconductor device.

### CROSS-REFERENCE TO RELATED APPLICATIONS

This application claims priority to U.S. Provisional Application Ser. No. 61/568,344, filed Dec. 8, 2011, which is incorporated by reference in its entirety.

The invention was made with government support under Agreement No. N00014-10-2-0001 awarded by The Office of Naval Research. The government has certain rights in the invention.

### BACKGROUND OF THE INVENTION

1. Field of the Invention

This invention relates to superconductors and more particularly relates to apparatuses, systems, and methods related to removable cryostat cartridges that contain superconductor material.

2. Description of Related Art

Superconductivity occurs in particular materials that are below a characteristic temperature, called the critical temperature. For example, solid mercury becomes a superconductor (“SC”) at about 4.2 Kelvin (“K”). High-temperature superconductors are materials that become superconductive at a relatively high critical temperature.

Superconducting magnets are typically electromagnets that have coils made of a superconducting material. Superconducting magnets can create larger magnetic fields than conventional electromagnets made with conductors that are not superconductors.

Superconductors may be useful in electric motors. For example, a superconducting magnet, or a superconductor with a trapped magnetic field, may replace a permanent field magnet or a conventional electromagnet in an electric motor.

### SUMMARY OF THE INVENTION

A cryostat cartridge is disclosed. In some embodiments, the cryostat cartridge may include a cryostat having a cryogen inlet and a cryogen outlet. Furthermore, the cryostat cartridge may include a superconductor material inside the cryostat configured to be cooled by a cryogen entering the cryostat through the cryogen inlet and exiting the cryostat through the cryogen outlet. In some embodiments, the cryogen inlet is configured to be detachable from a cryogen source. In some embodiments, the cryostat may be configured to be inserted into a superconductor device.

In some embodiments, the cryostat cartridge may be configured to be coupled to an external activation module for activating the superconductor material. The activation module may include the cryogen source, for example.

In some embodiments, the superconductor device may be an electric motor or generator. In addition, in some embodiments, the cryostat cartridge may be configured to lower the temperature of the superconductor material to a temperature at or below a critical temperature of the superconductor material. In some embodiments, the superconductor material may include a plurality of superconductor bulk materials, such as superconductor discs or superconductor toroids, for example. In some embodiments, the superconductor material may be a high-temperature superconductor.

In some embodiments, the cryostat cartridge may include thermal insulation. The thermal insulation may be vacuum insulation.

In some embodiments, the cryostat cartridge may also include a temperature sensor coupled to the cryostat. In addition, the cryostat cartridge may include a heating element coupled to the cryostat.

Methods are also disclosed. In some embodiments, the method includes the step of inserting a cryostat cartridge into an activation module. In addition, the method may include applying a magnetic field to the superconductor material. Also, in some embodiments, the method may include providing the cryogen from the cryogen source to the cryostat cartridge through the cryogen inlet. The method may also include removing the cryostat cartridge from the activation module.

In some embodiments, the method may include inserting the cryostat cartridge into a receptacle in a superconductor device, such as an electric motor. In some embodiments, the method may include inserting a cryostat cartridge into a superconductor device.

A motor is also disclosed. In some embodiments, the motor may include a rotor and a stator. The rotor may be configured to rotate relative to the stator. In some embodiments a receptacle may be coupled to the rotor or the stator. Furthermore, in some embodiments, the receptacle may be configured to allow the cryostat cartridge to be inserted and removed from the receptacle.

In some embodiments, the superconductor device does not have the capability to activate a superconductor cartridge when the superconductor cartridge is inserted into the receptacle.

In some embodiments, a receptacle may be fixedly coupled to the rotor. In some embodiments, a receptacle may be fixedly coupled to the stator. In addition, in some embodiments, a motor may include a plurality of receptacles distributed around the circumference of the rotor or the stator.

The term “coupled” is defined as connected, although not necessarily directly, and not necessarily mechanically.

The term “fixedly coupled” is defined as mechanically coupled so as to minimize the relative movement between the pieces being coupled together.

The terms “a” and “an” are defined as one or more unless this disclosure explicitly requires otherwise.

The terms “substantially” and its variations are defined as largely but not necessarily wholly what is specified, as understood by a person of ordinary skill in the art. In any embodiment of the present devices and methods, the term “substantially” and the term “about” may be substituted with “within [a percentage] of” what is specified, where the percentage includes 0.1, 1, 5, and/or 10, percent.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a method or apparatus that “comprises,” “has,” “includes” or “contains” one or more steps or elements possesses those one or more steps or elements, but is not limited to possessing only those one or more elements. Likewise, a step of a method or an element of an apparatus that “comprises,” “has,” “includes” or “contains” one or more features possesses those one or more features, but is not limited to possessing only those one or more features. Furthermore, an apparatus or structure that is configured in a certain way is configured in at least that way, but may also be configured in ways that are not listed.

Any embodiment of any of the present cryostat cartridges and the methods for using them can consist of or consist essentially of—rather than comprise/include/contain/have—any of the described elements and/or features. Thus, in any of the claims, the term “consisting of” or “consisting essentially of” can be substituted for any of the open-ended linking verbs recited above, in order to change the scope of a given claim from what it would otherwise be using the open-ended linking verb.

Other features and associated advantages will become apparent with reference to the following detailed description of specific embodiments in connection with the accompanying drawings.

### BRIEF DESCRIPTION OF THE DRAWINGS

The following drawings illustrate by way of example and not limitation. For the sake of brevity and clarity, every feature of a given structure is not always labeled in every figure in which that structure appears. Identical reference numbers do not necessarily indicate an identical structure. Rather, the same reference number may be used to indicate a similar feature or a feature with similar functionality, as may non-identical reference numbers.

FIG. 1 shows a cryostat cartridge.

FIG. 2 shows a cryostat cartridge in an activation module.

FIG. 3 shows a superconductor motor with two cryostat cartridges inserted into two receptacles on the rotor.

FIG. 4 is a flow chart showing a method of activating a cryostat cartridge and then inserting the cartridge into a superconductor device.

FIG. 5 is a flow chart showing a method for using a cryostat cartridge.

### DETAILED DESCRIPTION

Various features and advantageous details are explained more fully with reference to the non-limiting embodiments that are illustrated in the accompanying drawings and detailed in the following description. Descriptions of well-known starting materials, processing techniques, components, and equipment are omitted so as not to unnecessarily obscure the invention in detail. It should be understood, however, that the detailed description and the specific examples, while indicating embodiments of the invention, are given by way of illustration only, and not by way of limitation. Various substitutions, modifications, additions, and/or rearrangements within the spirit and/or scope of the underlying inventive concept will become apparent to those skilled in the art from this disclosure.

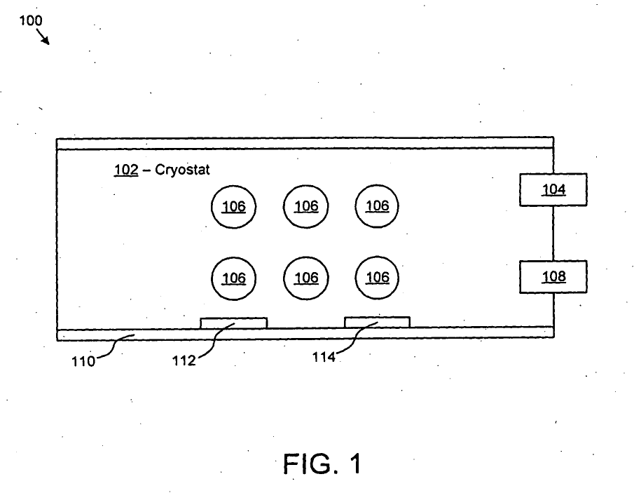

FIG. 1 illustrates one embodiment of a cryostat cartridge 100. The cryostat cartridge 100 includes a cryostat 102, which may be configured to help maintain the temperature inside the cryostat 102 at a particular temperature. The cryostat walls 110, for example, may include thermal insulation. The thermal insulation may be an insulating material, such as expanding foam, or the thermal insulation may include vacuum insulation.

The cryostat 102 includes a cryogen inlet 104 and a cryogen outlet 108. The cryogen inlet is configured to allow a cryogen to enter the cryostat 102. The cryogen may lower the temperature inside the cryostat 102, as well as any contents in the cryostat 102. The cryogen may be liquid nitrogen or liquid or gaseous helium, for example. Although not shown in FIG. 1, the cryogen may enter through the cryogen inlet 104 and may circulate through a cooling system, to the point where the SC may be bathed in a cryogen bath. In some embodiments, not shown, the cryostat 102 may contain baffles that help ensure that the cryogen circulates evenly through the cryostat.

Inside the cryostat 102 is a superconductor material 106. The superconductor material 106 may be configured in a variety of different shapes. For example, as shown in FIG. 1, the superconductor material 106 may comprise a plurality of separate individual structures, each made of a superconductor material 106. For example, the superconductor material 106 may be in the shape of a disk or toroid. The superconductor material 106 may include a high-temperature superconductor, and may be made of one or more of a variety of compositions, such as YBaCuO or BSCCO, for example. The superconductor material 106 may be configured or positioned to be cooled by a cryogen that passes through the cryogen inlet 104. For example, the superconductor material 106 may be physically coupled to cooling coils (not shown) that contain a cryogen. The cryostat 102 may also have a cryogen outlet 108 that is configured to allow the cryogen to exit the cryostat 102.

The cryostat cartridge 100 may also include a temperature sensor 112 coupled to the cryostat 102. The temperature sensor may be part of a system that monitors the temperature inside the cryostat 102 to ensure that the superconductor material 106 is at or below a particular temperature. In addition, the cryostat cartridge 100 may include a heating element 114, which may be configured to raise the temperature inside the cryostat 102.

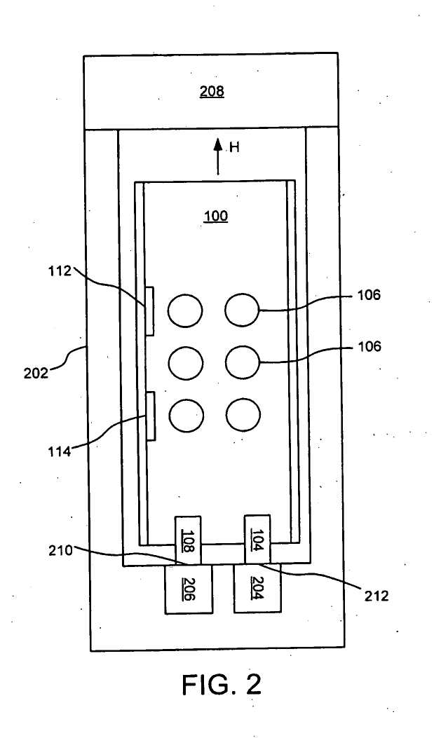

FIG. 2 shows an embodiment of a cryostat cartridge 100 that is inserted into an activation module 202. The activation module is configured to house the cryostat cartridge. Although in this embodiment the cryostat cartridge 100 is completely enveloped by the activation module 202, in some embodiments the cryostat cartridge 100 may only make contact with the activation module 202.

The activation module 202 may include a cryogen source 204. The cryogen source 204 is configured to be coupled to the cryogen inlet 104 at the inlet interface 212 and provide a cryogen to the cryostat cartridge 100. The cryogen source 204 is also configured to be decoupled from the cryogen inlet 104, such as when the cryostat cartridge 100 is removed from the activation module 202. Although the cryogen source 104 is shown as a single structure in FIG. 2, in some embodiments the source may be spatially removed from the valve or connector that makes a physical contact with the cryogen inlet. For example, the cryogen source 204 may include a tank of liquid nitrogen and a hose with a connector that connects the tank to the cryogen inlet 104.

This embodiment of the activation module 202 also includes a cryogen sink 206 (or return) that is configured to be coupled to the cryogen outlet 106 at the outlet interface 210. In some embodiments, the cryogen outlet 106 may be configured to let the cryogen dissipate without passing the cryogen to a cryogen sink 206.

One function of the activation module 202 may be to activate the superconductor material 106 inside the cryostat cartridge 100. As used herein, activating a superconductor material 106 means trapping a magnetic field in the superconductor material 106. For example, as someone of ordinary skill in the art will recognize, a magnetic field source 208 may be configured to apply a magnetic field (H) to the superconductor material 106. While the magnetic field is applied, the cryogen source 204 may cause a cryogen to enter the cryostat cartridge 202 through the cryogen inlet 104. The cryogen may lower the temperature of the superconductor material 106 from a temperature that is above the critical temperature of the superconductor material 106 to a temperature at or below the critical temperature. Once the superconductor material is at or below its critical temperature, the magnetic field (H) from the magnetic field source 208 may be removed, yet a magnetic field may be trapped in the superconductor material 106. As another example, the superconductor material 106 may be cooled to a temperature below the critical temperature and an external magnetic field, which may be a magnetic pulse, may then be applied to the superconductor material 106. The shape, magnitude, and duration of the magnetic pulse may affect the amount of magnetic field trapped in the superconductor material 106. The cryostat cartridge 100 may then be removed from the activation module 202.

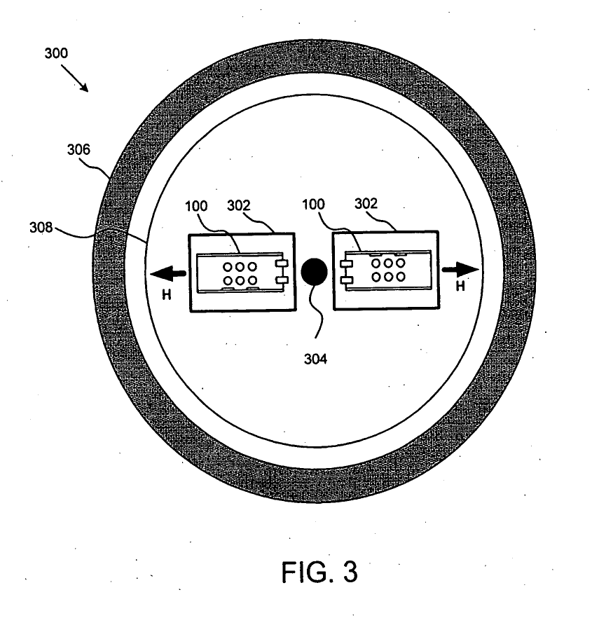

FIG. 3 shows an embodiment of a superconductor device 300. In this embodiment, the superconductor device 300 is a motor having a stator 306 and a rotor 308, where the rotor 308 is able to rotate relative to stator 306 around an axle 304. In this embodiment, there are two receptacles 302 that are coupled to the rotor 308. In some embodiments, one or more receptacles may be coupled to the stator 306 instead of, or in addition to, being coupled to the rotor 308. As shown in FIG. 3, the receptacles 302 may be distributed around the circumference of the rotor 308. The receptacles 302 are each configured to receive a cryostat cartridge 100. The cryostat cartridges 100 may be inserted and removed from the receptacles 302. Although not shown, the cryostat cartridges 100 may be activated in one or more activation modules 202 (as shown in FIG. 2) before they are inserted into the rotor 308. In FIG. 2, a single cryostat cartridge 100 is inserted into a single activation module 202. Similarly, in FIG. 3, a single cryostat cartridge 100 is inserted into a single receptacle 302. However, in some embodiments, a single activation module may be configured to receive and activate two or more cryostat cartridges 100. Also, a single receptacle 302 may be configured to receive two or more cryostat cartridges. By placing more than one cryostat cartridge 100 in a single activation module, the activation process may be accomplished in parallel, thereby reducing the time (or equipment) required to activate cryostat cartridges. In addition, by placing more than one cryostat cartridge in a single activation module 202, the two or more cryostat cartridges may be activated using a single magnetic source, which may help ensure that the trapped magnetic field is the same or similar in the two or more cryostat cartridges. By placing two or more cryostat cartridges 100 in each receptacle 302, the amount of trapped charge available to the superconductor device 300 may be larger than if only a single cryostat cartridge 100 is used in each receptacle 302. In some embodiments, configuring the receptacles 302 to receive two or more cryostat cartridges 100 may allow the design to accommodate smaller, lighter, cryostat cartridges 100.

In some embodiments, the superconductor device 300 may not have the capability of activating the cryostat cartridge 100 while the cryostat cartridge is inserted into the superconductor device 300. Because the cryostat cartridge 100 can be activated in an external activation module 202, the superconductor device need not have a cryogen source 204 or a magnetic field source. As such, the superconductor device 300 may have fewer parts, less complexity, and lower weight, for example, than a superconductor device that has the ability to activate a superconductor material used in the superconductor device.

In addition to a motor as described above in connection to FIG. 3, a superconductor device 300 may be a generator used to convert mechanical energy into electrical energy.

The schematic flow chart diagrams that follow are generally set forth as logical flow chart diagrams. As such, the depicted order and labeled steps are indicative of one embodiment of the present methods. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. Additionally, the order in which a particular method occurs may or may not strictly adhere to the order of the corresponding steps shown.

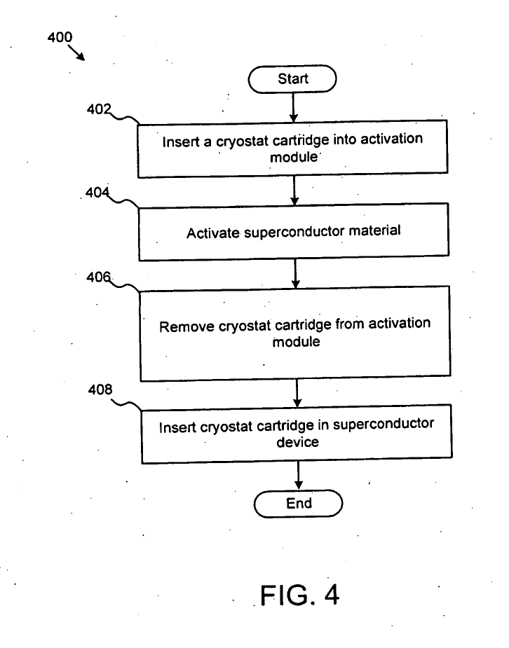

FIG. 4 shows a flow chart of one embodiment of a method 400 for using a cryostat cartridge 100. Method 400 begins with step 402, which is to insert a cryostat cartridge 100 into an activation module 202 as shown in FIG. 2. The superconductor material 106 inside the cryostat cartridge 100 is activated at step 404. As described above, when the cryostat cartridge 100 is inserted in the activation module 202, a cryogen may be inserted into the cryostat cartridge 100 from a cryogen source 204 through the cryogen inlet 104. When the temperature of the superconductor material 106 is lowered from a temperature that is above the superconductor material's critical temperature to a temperature at or below the critical temperature a magnetic field (H) may be applied to the superconductor material 106 by the magnetic field source 208. As a result, a magnetic field may become trapped in the superconductor material 106. At step 406, the cryostat cartridge is removed from the activation module.

At step 408, the cryostat cartridge 100 is inserted into a superconductor device. A superconductor device is a device that makes use of a superconductor, such as the electric motor shown in FIG. 3.

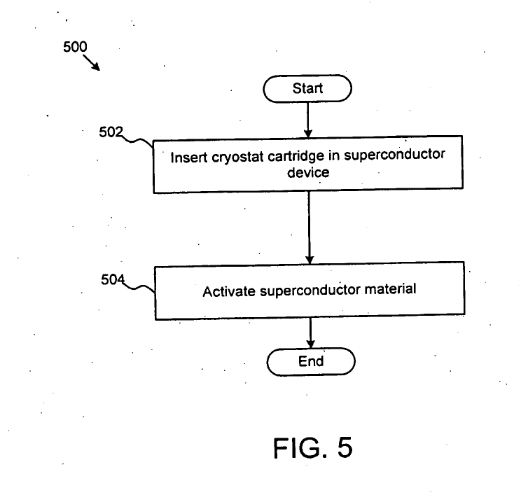

FIG. 5 shows a flow chart of one embodiment of a method 500 for using a cryostat cartridge 100. Method 500 begins with step 502, where the cryostat cartridge 100 is inserted into superconductor device 300. As described above, superconductor device 300 may be an electric motor or generator, for example. At step 504, the superconductor material is activated. In this embodiment, the superconductor material 106 is activated after being inserted into the superconductor device 300. As such, the cryostat cartridge may be inserted into the superconductor device when the superconductor material 106 has little or no trapped magnetic field.

It should be understood that the present apparatuses, systems, and methods are not intended to be limited to the particular forms disclosed. Rather, they are to cover all modifications, equivalents, and alternatives falling within the scope of the claims. Modifications may be made to the disclosed apparatuses and components may be eliminated or substituted for the components described above where the same or similar results would be achieved. For example, there are many different superconductor compositions that may be used with the disclosed embodiments without departing from the spirit of the disclosure. Furthermore, cryostat cartridges may be manufactured in various sizes and configurations without departing from the spirit of this disclosure.

The claims are not intended to include, and should not be interpreted to include, means-plus- or step-plus-function limitations, unless such a limitation is explicitly recited in a given claim using the phrase(s) “means for” or “step for,” respectively.

1. A cryostat cartridge comprising:
a cryostat having a cryogen inlet and a cryogen outlet; and
a superconductor material inside the cryostat configured to be cooled by a cryogen entering the cryostat through the cryogen inlet and exiting the cryostat through the cryogen outlet;
wherein the cryogen inlet is configured to be detachable from a cryogen source, and the cryostat is configured to be inserted into a superconductor device.

2. The cryostat cartridge of claim 1 being configured to be coupled to an external activation module for activating the superconductor material.

3. The cryostat cartridge of claim 3, wherein the activation module comprises the cryogen source.

4. The cryostat cartridge of claim 1, wherein the superconductor device is an electric motor.

5. The cryostat cartridge of claim 1, the cryostat cartridge being configured to lower the temperature of the superconductor material to a temperature at or below a critical temperature of the superconductor material.

6. The cryostat cartridge of claim 1, wherein the superconductor material comprises a plurality of superconductor discs or superconductor toroids.

7. The cryostat cartridge of claim 1, wherein the cryostat cartridge comprises thermal insulation.

8. The cryostat cartridge of claim 1, wherein the superconductor material is a high-temperature superconductor.

9. The cryostat cartridge of claim 1, further comprising a temperature sensor coupled to the cryostat.

10. The cryostat cartridge of claim 1, further comprising a heating element coupled to the cryostat.

11. A method comprising:
inserting a cryostat cartridge into a superconductor device, wherein the cryostat cartridge comprises:
a cryostat having a cryogen inlet and a cryogen outlet; and
a superconductor material inside the cryostat configured to be cooled by a cryogen entering the cryostat through the cryogen inlet and exiting the cryostat through the cryogen outlet;
wherein the cryogen inlet is configured to be detachable from a cryogen source;
providing the cryogen from the cryogen source to the cryostat cartridge through the cryogen inlet.

12. The method of claim 11, wherein the superconductor device is an electric motor.

13. A motor comprising:
a rotor and a stator, wherein the rotor is configured to rotate relative to the stator;
a receptacle coupled to the rotor or the stator, wherein the receptacle is configured to receive a cryostat cartridge, the cryostat cartridge comprising:
a cryostat having a cryogen inlet and a cryogen outlet; and
a superconductor material inside the cryostat configured to be cooled by a cryogen entering the cryostat through the cryogen inlet and exiting the cryostat through the cryogen outlet;
wherein the receptacle is further configured to allow the cryostat cartridge to be inserted and removed from the receptacle.

14. The motor of claim 13, further comprising a cryogen source operable to provide the cryostat cartridge with the cryogen through the cryogen inlet.

15. The motor of claim 13, wherein the receptacle is fixedly coupled to the rotor.

16. The motor of claim 13, wherein the receptacle is fixedly coupled to the stator.

17. The motor of claim 13, further comprising a plurality of receptacles distributed around the circumference of the rotor or stator.
